(19) United States
(12) Patent Application Publication
(10) Pub. No.: US 2004/0066953 A1
(43) Pub. Date: Apr. 8, 2004

(54) Recognising people using a mobile appliance

(76) Inventor: Gerhard Bock, Gauting (DE)

Correspondence Address: BELL, BOYD & LLOYD, LLC, P. O. BOX 1135, CHICAGO, IL, 60690-1135, US

(21) Appl. No.: 10/470,398

(22) PCT Filed: Jan. 29, 2001
(86) PCT No.: PCT/EP01/00929

(51) Int. Cl. G06K 9/00

(52) U.S. Cl. 382/115

(57) ABSTRACT

The present invention relates to a terminal of the communication or data processing technique, which includes a person-related database in which images of people are stored. Parts are then provided to compare inputted personal characteristics with such images, and the person or people determined is/are then outputted in the form of data and/or an image.

### BACKGROUND OF THE INVENTION

Such terminals may be, for example, a video mobile communication device, known as a video mobile apparatus, or a notebook, a palmtop or a PDA personal digital assistant).

People in business have to deal with a large number of contacts. It is not always easy to put a name to a face when meetings are infrequent. It is particularly unpleasant not to be able to remember the name of the person you meet in a chance encounter.

Image-supported address books on personal computers are known, in which the search process or person recognition is carried out manually.

An object of the present invention is to use a terminal of the type referred to above for person recognition.

### SUMMARY OF THE INVENTION

Accordingly, in an embodiment of the present invention, a communication terminal is provided which includes a person-related database in which images of people are stored, parts for comparing input personal features with the stored images, and parts for outputting an identified person or persons in the form of data and/or an image.

In an embodiment, the data processing terminal is provided which includes a person-related database in which images of people are stored, parts for comparing input personal features with the stored images, and parts for outputting an identified person or persons in the form of data and/or an image.

In an embodiment, a video mobile communication device is provided which includes a camera, a person-related database in which images of people are stored, parts for comparing a recorded image using the camera with the stored images, and parts for outputting an identified person or persons in the form of data and/or an image.

Additional features and advantages of the present invention are described in, and will be apparent from, the following Detailed Description of the Invention.

### DETAILED DESCRIPTION OF THE INVENTION

The present invention is based on a video mobile communication device or a palmtop, on which a person-related database with images is stored. The images can be fed in via an integral camera in the case of the video mobile communication device. In the case of the palmtop, the images are fed in, for example, via external image recorders, with the nature and manner being of minor importance to the present invention. The terminal, particularly the mobile terminal, has a person-related database, such as an address book or a telephone book, as well as associated images.

According to the present invention, a comparison is made in the terminal between input personal features and the images. Such personal features are, for example, the shape of the face, a beard or glasses, or other content detailed on the images. The features preferably are input via the existing keyboard or, for example, via voice recognition. The manually input features are compared with the image stored in the database and the result is output.

The output result is for example a list of those people whose images correspond best to the input features. The person or people can be output with names and, if required, addresses or telephone numbers, and also via the associated image.

In one embodiment of the present invention, the camera in the video mobile communication device is used to record the person to be identified. The recorded image is compared with the stored images and a list of people is again output whose images show a sufficient resemblance to the image of the person to be identified. The list preferably contains names and other personal data.

Although the present invention has been described with reference to specific embodiments, those of skill in the art will recognize that changes may be made thereto without departing from the spirit and scope of the present invention as set forth in the hereafter appended claims.

1. Terminal of the communication or data processing technique comprising a person-related database, in which images of people are stored,
characterized by
means for comparing input personal features with the images, and output of the identified person or people in the form of data and/or image.

2. Video mobile communication device with a camera and with a person-related database, in which images of people are stored,
characterized by
means for comparing an image recorded using the camera with the stored images, and
output of the identified person or people in the form of data and/or image.
